(19) United States
(12) Patent Application Publication
(10) Pub. No.: US 2016/0107164 A1
(43) Pub. Date: Apr. 21, 2016

(54) Closure System For Ball Mills And Method For Opening And Closing Ball Mills

(71) Applicant: NETZSCH-Feinmahltechnik GmbH, Selb (DE)

(72) Inventors: Udo Enderle, Marktredwitz (DE); Thomas Goller, Schwarzenbach/Saale (DE)

(21) Appl. No.: 14/978,703

(22) Filed: Dec. 22, 2015

Related U.S. Application Data
(63) Continuation of application No. PCT/DE2014/000329, filed on Jun. 25, 2014.

(30) Foreign Application Priority Data
Jul. 5, 2013 (DE) 102013107084.1

(51) Int. Cl. B02C 17/18

(52) U.S. Cl. CPC B02C 17/182

(57) ABSTRACT

A closure system for ball mills, a method for opening and closing ball mills, and a ball mill including a milling vessel with an end opening which can be closed by a closure mechanism. The closure mechanism assigned a first flange with first connecting devices, and the end opening of the milling vessel assigned a second, mating flange with second connecting devices. The closure mechanism can be fastened on the milling vessel via the first and the second connecting devices.

### FIELD OF THE INVENTION

The present invention relates to a closure system for ball mills and a method for opening and closing ball mills.

### BACKGROUND OF THE INVENTION

The invention relates to a closure system for large horizontally orientated ball mills. The ball mill is a device for the coarse, fine and extremely fine size-reduction or homogenisation of grinding stock. It comprises a grinding chamber, which is caused to rotate and in which grinding stock is size-reduced by grinding bodies. Ball mills are usually constituted by an approximately circular-cylindrical grinding container mounted horizontally rotatable. The mills are filled through a central opening in one of the end walls. The discharge is dependent on the design and takes place for example through slots in the grinding chamber wall at the end of the mill, the grinding bodies being held back.

A special form of the ball mill is the agitator ball mill. Agitator ball mills comprise a usually approximately cylindrical grinding container disposed vertically or horizontally, which is filled up to 70-90% with grinding bodies. The grinding container is usually mounted stationary, non-rotating in the case of agitator ball mills. An agitator with suitable agitator elements provides for the intensive movement of the grinding bodies. The grinding stock suspension is continuously pumped through the grinding chamber. The suspended solids are size-reduced or dispersed by impact or shearing forces between the grinding bodies. The separation of grinding stock and grinding bodies takes place by means of a suitable separation system at the discharge of the mill.

A ball mill is disclosed for example in U.S. Pat. No. 2,542,482 A. The latter comprises a rotatable drum with two circular side faces. One of the circular side faces forms the lid, which is screwed onto the drum. An analogously constituted fastening of the lid is found for example in U.S. Pat. No. 4,018,393 A.

The lid of large mills, for example of ball mills or agitator ball mills, with a diameter of the grinding container of several metres, has a great weight on account of its size, which makes closing of the grinding container difficult. In the case of an agitator ball mill, the agitator and the drive are usually disposed on the lid, as a result of which the latter is even heavier and more difficult to handle. However, the lid must be able to be repeatedly removed as quickly and easily as possible in order for example to clean the inside of the grinding container, to replace defective stirring means of the agitator, to replace defective and/or worn parts of the grinding container lining, to replace the grinding balls in the grinding container etc. For this reason, ball mills are known wherein the grinding container is mounted horizontally displaceable and can be moved away from the lid. Such and similar mills are known for example from DE 69525334 T2 and WO 2010068993 A1. The grinding container and the lid conventionally comprise flanges, which comprise for example aligned openings so that the grinding container and the lid can be screwed together via the flanges. Long working times spent on removing the screws are in particular a problem when removing of the lid. The problem is compounded, on account of the size, by the difficult accessibility of the screws, especially at the upper and lower side of the flanges.

The problem underlying the invention is to provide a closure device for a ball mill, with which the lid can be fastened reliably, firmly and in a sealing manner on the ball mill and wherein the lid can be removed from the grinding container quickly and easily, in order to permit easy and simple access to the interior of the grinding container. Furthermore, it is based on the problem of providing a method for the simple, rapid and reliable closing and opening of a ball mill.

The above problems are solved by a closure system for ball mills and a method for opening and closing ball mills according to the invention.

### SUMMARY OF THE INVENTION

The invention relates to a closure system for ball mills with a horizontally or vertically mounted grinding container. Within the scope of application, the term ball mill is used both for ball mills with a rotating grinding container as well as for agitator ball mills with a non-rotating grinding container and agitating tools. In the case of agitator ball mills, the grinding container can be mounted rotatable as well as non-rotatable. The grinding container comprises an end-face opening. In particular, the grinding container is a hollow cylinder open on one side, which is disposed horizontally and comprises a circular opening at one of the free ends. Other geometries of the grinding container, for example containers with a largely symmetrically polygonal, in particular an octagonal cross-section or similar, are also conceivable and are intended to be covered by the invention. The opening is closed with a closure device, in particular with a lid. For this purpose, the closure device comprises a first flange with first connecting devices. The end-face opening of the grinding container comprises a second counter-flange with second connecting devices. The closure device can be fastened to the grinding container in a friction-locked manner by means of the first and the second connecting devices.

According to the invention, the first or the second connecting devices are each a component part of at least one rotatable, at least partially annular adjustment element. When the adjustment element is mentioned below in the singular, this is also intended to include a plurality of rotatable, partially annular adjustment elements, in particular a plurality of adjustment elements which together broadly form a ring shape.

The adjustment element can occupy an open working position, in which the first and second connecting devices engage loosely into one another. By rotation in a first direction of rotation, the at least one, at least partially annular adjustment element is transferred into a closed locking position. In this second closed locking position, the first and second connecting devices are rotated towards one another. In particular, the first or the second connecting devices are rotated with respect to the first working position. By virtue of means producing a friction-locked connection, a clamped operative connection between the closure device and the grinding container is constituted in a friction-locked manner.

The rotation of the adjustment element is a rotary motion of only a few degrees, for example the adjustment element rotates through a rotation angle between 5° and 20°, in particular through approx. 10°-15°. The closure device and the grinding container are pressed axially in the end position by the rotation of the adjustment element in combination with means producing a friction-locked connection, so that the closure device is fastened to the grinding container in a sealing manner.

The grinding container is preferably horizontally mobile, whilst the closure device is disposed for the most part stationary. For the fastening of the closure device on the grinding container, the latter is moved into a first closure position, in which the first connecting devices of the closure device and the second connecting devices of the grinding container flange engage loosely into one another, or in which the second connecting devices of the grinding container flange engage through the first connecting devices of the closure device. The locking then takes place by the rotation of the adjustment element and the means producing a friction-locked connection. In order, for example, to clean the grinding container or to remove grinding bodies etc., the locking between the grinding container and the closure device is released, wherein the adjustment element is rotated in the opposite direction to the first direction of rotation and the friction-locked and/or form-fit connection via the means producing the friction-locked connection is removed. After the rotation of the adjustment element in the opposite direction, the first and second connecting devices are disposed in such a way that they engage only loosely into one another. By a horizontal movement of the grinding container away from the closure device into a maintenance position, easy access to the interior of the grinding container is enabled.

For the adjustment of the at least one rotatable, at least partially annular adjustment element by rotation, there is assigned to the latter at least one suitable hydraulic, pneumatic and/or electronic adjusting means, in particular at least one hydraulic device. According to a preferred embodiment, provision is also made such that centring means are assigned to the flange and the counter-flange, which force the correct alignment of the closure device at the grinding container and thus also prevent wedging of the first and second connecting devices. For example, the flange comprises a centring pin, which engages and is guided in a corresponding bore of the counter-flange. At least two centring pins are preferably provided in order that the grinding container and the closure device are properly aligned with one another when they are brought together. Further centring means known to the person skilled in the art are also intended to be covered.

According to a first embodiment of the invention, the first connecting devices of the closure device are a component part of a rotatable, annular adjustment element. In a first open working position of the adjustment element, the first connecting devices are located in a first open position aligned with the second connecting devices. If the grinding container is now displaced horizontally along its longitudinal axis in the direction of the closure device, the second connecting devices of the grinding container loosely engage in the first connecting devices of the closure device, or engage through the latter. By rotation of the adjustment element, the latter is transferred into the locking position. The first connecting devices are thereby rotated into a second, at least partially closed position. In the second locking position of the adjustment element, the first and the second connecting devices are rotated at least partially towards one another. The first and the second connecting devices are preferably rotated towards one another to an extent such that they are no longer aligned parallel with the longitudinal axis of the grinding container, but are disposed at least for the most part beside one another.

The rotatable, annular adjustment element is constituted for example as an external ring, which is assigned rotatably to the first flange of the closure device. The external diameter of the external ring is preferably constituted greater than the external diameter of the first flange. According to alternative embodiment, the external diameter of the external ring is preferably constituted identical to the external diameter of the first flange. The external ring comprises inwardly directed first teeth, i.e. the first teeth of the external ring are directed towards the ring centre-point of the external ring. In particular, a plurality of identically constituted first teeth are disposed uniformly spaced apart at the internal diameter of the external ring, so that the latter form a kind of internal ring gear. The gaps between the first teeth each form the first connecting devices. At least one free space is constituted at least in regions between the first teeth and the first flange. This free space is preferably constituted with a size such that the second, subsequently described teeth of the grinding container flange can be pushed completely into the gaps between the first teeth. Alternatively, the first teeth can have an undercut constituted towards the first flange. The second connecting devices project in regions beyond the external diameter of the grinding container flange. In particular, the second connecting devices are constituted as outwardly directed second teeth. A kind of external ring gear is disposed on the grinding container flange. The second teeth are dimensioned such that, in a first working position, they can be pushed by the horizontal displacement of the grinding container into or through the gaps between the first teeth, i.e. between the inwardly directed first teeth of the adjustment element of the closure device. Second connecting devices are correspondingly pushed into first connecting devices, which are a component part of the adjustment element of the closure device. For this purpose, the grinding container is moved towards the closure device to an extent such that the second connecting devices for the most part abut against the flange of the closure device.

The locking position is adjusted by rotating the closure element in a first direction of rotation. The first direction of rotation is defined for example as the closing direction of rotation in the clockwise direction. When the closure element is rotated in the clockwise direction, the first connecting devices are rotated with respect to the second connecting devices. In particular, the first teeth of the rotatable, annular adjustment element are pushed at least partially over the second connecting devices, i.e. over the outwardly directed second teeth of the grinding container flange. The second teeth are then disposed at least partially in the free space or in the undercut between the first, inwardly directed teeth of the external ring and the flange of the closure device. Preferably, the first teeth for the most part completely overlap the second teeth in the locking position of the adjustment element.

In order to generate a particularly good friction-locked connection, wedge elements can be assigned to the second connecting devices on the side facing the grinding container, said wedge elements widening normal to be grinding container flange against the first direction of rotation of the external ring of the closure device. Alternatively or in addition, wedge elements can also be disposed on the lid side of the first teeth. The wedge elements on the first teeth are referred to below as the first wedge elements and the wedge elements on the second teeth are referred to as the second wedge elements.

When the first wedge elements on the first teeth of the closure device are viewed from the container side, their thickness increases normal to the plane of the open end face of the grinding container in each case in the anticlockwise direction. When the open end face of the grinding container is closed with the closure device, the first wedge elements together with the second wedge elements of the second teeth disposed on the grinding container flange bring about the creation of a friction-locked connection, in particular since the contact pressure is additionally increased by the respective widening of the first and second wedge elements.

According to an embodiment of the invention, provision is made for the first or the second wedge elements to be disposed displaceably on the first or second teeth. An adjustment can be made for example by means of a slotted-hole fixture or other suitable adjustment options. The wedge elements are preferably adjusted once when the ball mill is put into operation. Alternatively and/or in addition, provision can be made to readjust, if need be, the adjustable wedge elements, for example when the sealing elements become thinner, in order always to ensure a sufficient friction-locked connection.

In this connection, it should also be pointed out that it is of course advisable to constitute the wedge elements so as to be individually exchangeable, so that the latter can each be exchanged individually in the event of damage.

When the second locking position is adjusted by the rotation of the adjustment element, the wedge elements enhance the friction-locked connection between the first inwardly directed teeth of the external ring of the adjustment element of the closure device and the second outwardly directed teeth of the grinding container flange. By rotating the adjustment element into the closed locking position, an additional pressure is produced by the wedge elements in the axial direction of the grinding container. A sealing element, for example in the form of a rubber seal or an approx. 10 mm to 15 mm thick rubber sheet, is preferably assigned to the closure device on the grinding container side. As a result of the additional pressure in the axial direction, the rubber seal or rubber sheet is compressed and the grinding container is thus sealed against the closure device. According to an embodiment of the invention, the sealing elements are wearing parts.

The grinding container including the grinding container flange, the closure device and the rotatable external ring with the first teeth are preferably made of a first material, in particular of steel or special steel. The wedge elements on the second connecting devices are preferably made of a second different material, for example of brass or a copper-zinc alloy etc. The material of the wedge elements is selected such that there is the least possible adhesive friction between the material of the external ring and the material of the wedge elements. As a result of a low adhesive friction, for example as a result of a low adhesive friction between brass and steel, undesired jamming does not therefore occur during the rotation of the external ring.

For the rotation of the rotatable, annular adjustment element according to the first described embodiment, two hydraulic cylinders, for example, are provided, which are disposed on the rotatable, annular adjustment element and on a frame carrying the ball mill and bring about the necessary rotation of the adjustment element.

According to a second embodiment of the invention, a plurality of rotatable, partially annular adjustment elements with two connecting devices are assigned to the grinding container flange. Four largely quarter-circle-shaped adjustment elements are preferably provided. In an open working position of the adjustment elements, the second connecting devices are located in a first open position, so that the first connecting devices of the closure device can engage in an aligned manner through the second connecting devices. The second connecting devices are transferred into a second closed position by preferably simultaneous and joint rotation of the adjustment elements. Provision can be made here such that all the adjustment elements rotate in a common direction of rotation. Alternatively, provision can be made such that some of the adjustment elements rotate in the clockwise direction and the other adjustment elements in the anticlockwise direction. Additional axial displacement devices are assigned to the first connecting devices, by means of which axial displacement devices the first connecting devices can be displaced parallel to the longitudinal axis of the grinding container. Hydraulic, pneumatic or electric means known to the person skilled in the art can be used as an axial displacement device. To close the grinding container, the latter is moved towards the closure device, so that the flange and the counter-flange almost make contact. The grinding container is usually moved so close to the closure device that a gap between 5 mm to 40 mm, preferably between 10 mm to 25 mm, is constituted between the grinding container and the closure device, said gap being uniform and running around the entire circumference. The first connecting devices thereby engage through the second connecting devices. The first connecting devices can also be displaced or extended in the direction of the grinding container, subsequently or largely simultaneously, by means of their respective axial displacement devices. Hydraulic cylinders, for example, or other suitable means serve as axial displacement devices. The axial displacement devices can be controlled individually or jointly. In this second embodiment, the axial displacement devices at the same time represent the means producing the friction-locked connection, as will be explained in the following.

The first connecting devices are constituted for example as hydraulically extendable bolts with a widened free end region, in particular a widened mushroom-like end region. The first connecting devices are passed through the second connecting devices, if need be with the aid of the axial displacement devices, in such a way that the widened free mushroom-like end regions are located behind the second connecting devices, i.e. behind the adjustment elements on the grinding container flange. The second connecting devices comprise a through-passage region and a support region with a support face for the widened end region of the first connecting devices. The through-passage region and the support region are connected to one another via a central region. The central region is constituted for example as a slotted hole. In the working position of the rotatable, partially annular adjustment elements, the second connecting devices are aligned in such a way that, when the grinding container is moved towards the closure device, the first connecting devices can simply be pushed through the through-passage regions of the second connecting devices. By rotating the partially annular adjustment elements into the locking position, the second connecting devices are displaced via the slotted hole with respect to the first connecting devices in such a way that the free end regions of the first connecting devices are now each positioned in front of the support regions of the second connecting devices. By means of the hydraulic cylinders, the first connecting devices are drawn towards the closure device. The widened end region is thus pressed against the support face of the second connecting device and a contact pressure is produced between the widened end region and the support region of the second connecting device and thus a friction-locked connection between the grinding container and the closure device, as a result of which the grinding container can be moved up completely to the closure device and thus closed with the latter firmly and in a sealing manner.

The first connecting device, i.e. the bolt with the widened mushroom-like end region, can for example be constituted such that it can easily be detached from the respective hydraulic cylinder. The bolt is guided in a socket and screwed with the hydraulic cylinder.

According to an alternative embodiment, provision is made such that not every first connecting device has its own hydraulic cylinder assigned to it as an axial displacement device, but that a plurality of first connecting devices are coupled with one hydraulic cylinder and are thus adjusted jointly. For example, provision is made such that three bolt-shaped first connecting devices each with a widened mushroom-like end region are each assigned to a common hydraulic cylinder.

For the rotation of the rotatable, partially annular adjustment elements, suitable hydraulic, pneumatic or electronic means are assigned to each of these elements. For example, at least one hydraulic cylinder, preferably two cooperating hydraulic cylinders are assigned in each case to the adjustment elements. The rotation of the adjustment elements for the opening or closing of the closure system preferably takes place largely synchronously.

The adjustment, i.e. the rotation of the adjustment elements and/or the application of the friction-locked connection by means of the axial displacement devices, can also take place pneumatically and/or electronically.

The invention also relates to a method for opening and closing a ball mill, wherein the ball mill comprises a horizontally disposed grinding container with an end-face opening, which can be closed with a closure device. The ball mill further comprises a closure system with at least one rotatable, at least partially annular adjustment element with first connecting devices on the closure device or with second connecting devices on the grinding container. In particular, the ball mill comprises a closure system according to the first or second embodiment described above.

In a working position, the first and the second connecting device engage in an aligned manner into one another and the first connecting devices engage in an aligned manner through the second connecting device or the second connecting devices engage in an aligned manner through the first connecting devices. The at least one adjustment element is transferred by rotation into a closed locking position. During this rotation of the at least one adjustment element, the first and second connecting devices are rotated towards one another. Via means producing a friction-locked connection, a clamped operative connection between the closure device and the grinding container is produced in a friction-locked manner

For the closing of the ball mill, the grinding container is moved in the axial direction towards the closure device. After the first and second connecting devices have engaged into or through one another, the at least one adjustment element is rotated in the first direction of rotation and a friction-locked connection between the closure device and the grinding container is produced. For the opening of the ball mill, the friction-locked connection between the closure device and the grinding container is released and the adjustment element is rotated in a second counter-direction, opposite the first direction of rotation. The grinding container is then moved in the axial direction, more precisely away from the closure device. The first and second connecting devices disposed engaging into or through one another in an aligned manner are thus pulled apart and spaced apart from one another.

The four largely quarter-circle-shaped adjustment elements are disposed on the outer edge of the grinding container flange and each cover, for example, an angle between 75° and 85°, in particular an angle of approx. 80°. An approx. 10° adjustment range is present in each case between the adjacent adjustment elements each covering approx. 80°. The purpose of this is to make the necessary free space available for the rotary adjustment of the adjustment elements. In the represented example of embodiment, the rotation of the adjustment element takes place for example through approx. 2° in each case. The required rotation can be varied and is dependent particularly on the spacing between the through-passage region and the support region of the second adjustment elements.

The number of the first and second connecting devices can be adapted both in the first and in the second described embodiment. Particularly in the case of grinding containers and closing devices with a large diameter, for example with a diameter of several metres, the number is correspondingly increased in order to ensure a firm, reliable and sealing fastening.

The closure system is a quick-action closure, by means of which the traversable grinding container can, quickly and easily and in particular without great manual effort, be flanged-mounted on and dismantled from a stationary closure device, in particular a stationary bearing pedestal, wherein an agitator, a corresponding drive and optionally further components are also assigned to the closure device.

### BRIEF DESCRIPTION OF THE DRAWINGS

Examples of embodiment are intended to explain the invention and its advantages in greater detail below with the aid of the appended figures. The size ratios of the individual elements with respect to one another in the figures do not always correspond to the actual size ratios, since some forms are represented simplified and other forms are represented enlarged in relation to the other elements for the sake of better illustration.

FIG. 1 shows a diagrammatic transverse cross-section through a ball mill,

FIG. 2 shows a diagrammatic longitudinal cross-section through an agitator ball mill.

FIGS. 3 to 10 show different views and details of a first embodiment of a closure system according to the invention for a ball mill.

FIGS. 11 to 17 show different views and details of a second embodiment of a closure system according to the invention for a ball mill.

### DETAILED DESCRIPTION OF THE INVENTION

Identical reference numbers are used for identical or identically acting elements of the invention. Furthermore, for the sake of clarity, only reference numbers that are required for the description of the given figure are represented in the individual figures. The represented embodiments only represent examples as to how the device according to the invention or the method according to the invention can be constituted and do not represent a conclusive limitation.

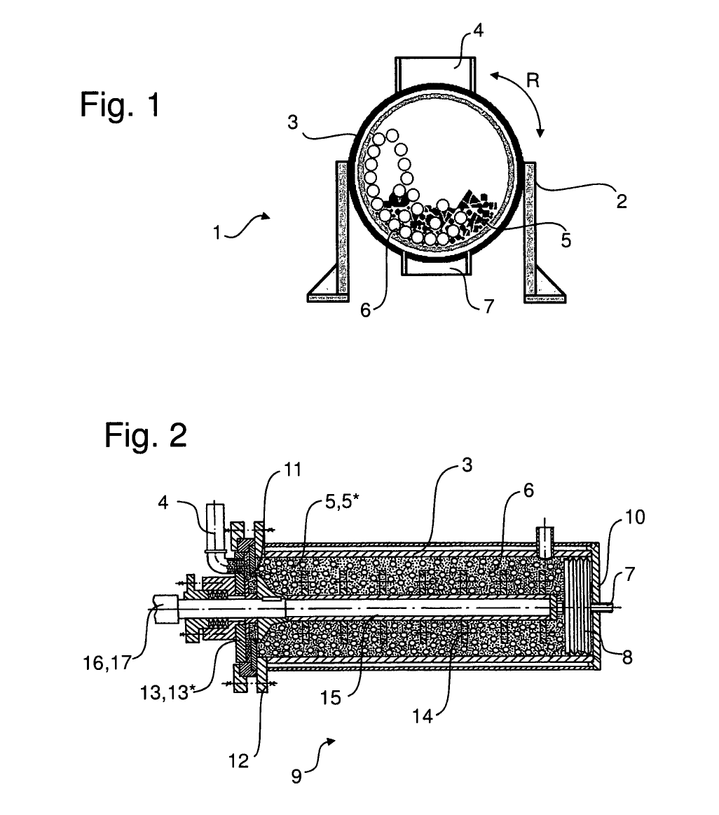

FIG. 1 shows a diagrammatic cross-section through a ball mill 1. Cylindrical grinding container 3 is mounted in a horizontally rotatable manner in a bearing frame 2. Grinding stock 5 is filled into grinding container 3 by means of a grinding stock supply device 4. Grinding stock supply device 4 is usually assigned to a first circular end wall (not represented). So-called grinding balls 6 or other suitable grinding aids are present in the interior of grinding container 3. By rotation R of grinding container 3, grinding stock 5 is ground down by grinding balls 6 and thus size-reduced. The output of size-reduced grinding stock 5 takes place by means of a grinding stock removal device 7 which, in the represented embodiment, is assigned to the second circular end wall lying opposite the first end wall. In particular, grinding balls 6 are held back at grinding stock removal device 7 and remain in grinding container 3.

FIG. 2 shows a diagrammatic longitudinal cross-section through an agitator ball mill 9. The latter also comprises a horizontally mounted grinding container 3. It can also be seen that a grinding stock removal device 7 with separation system 8 is assigned to a first end wall 10. The other second end wall 11 of grinding container 3 is constituted open and comprises a grinding container flange 12. Open end wall 11 of grinding container 3 is closed with a lid 13 with a lid flange 13*. Sealing elements are disposed on lid 13 on the container side for the purpose of a sealing fastening. Furthermore, grinding stock supply device 4 is assigned to lid 13, by means of which grinding stock supply device grinding stock 5 is introduced into grinding container 3. Grinding container 3 is filled with grinding balls 6 and also comprises agitator elements 14, which provide for the intensive movement of grinding balls 6, while a grinding stock suspension 5* for example is continuously pumped through the grinding chamber of grinding container 3. Agitator elements 14 are disposed for example on a common drive shaft 15, which is driven by a suitable drive means 16. Drive means 16 is for example an electric motor 17 and is disposed on the outer side of lid 13.

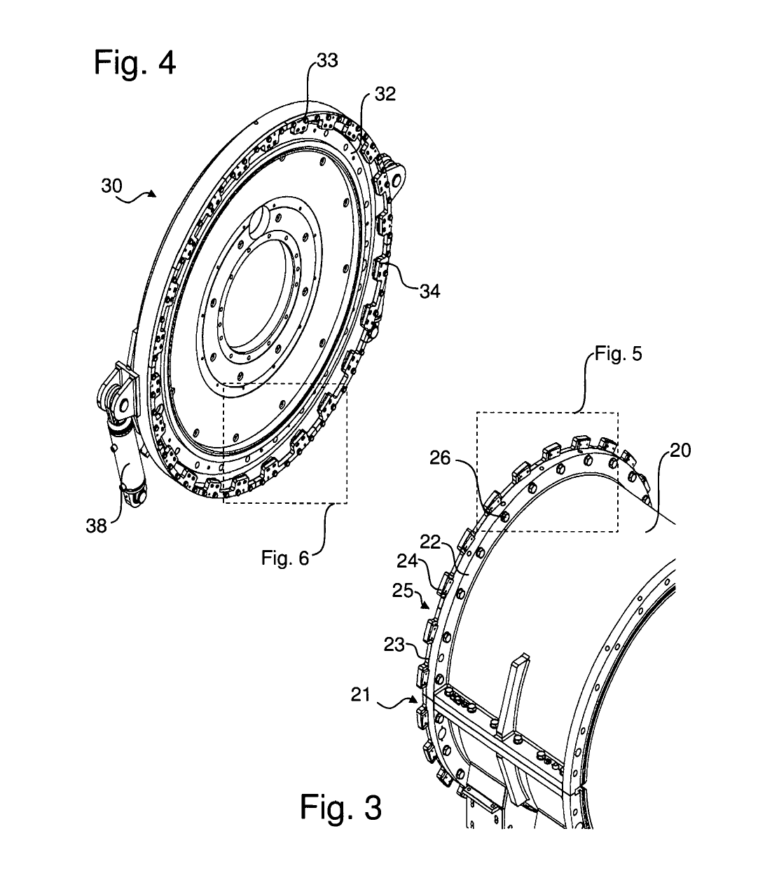

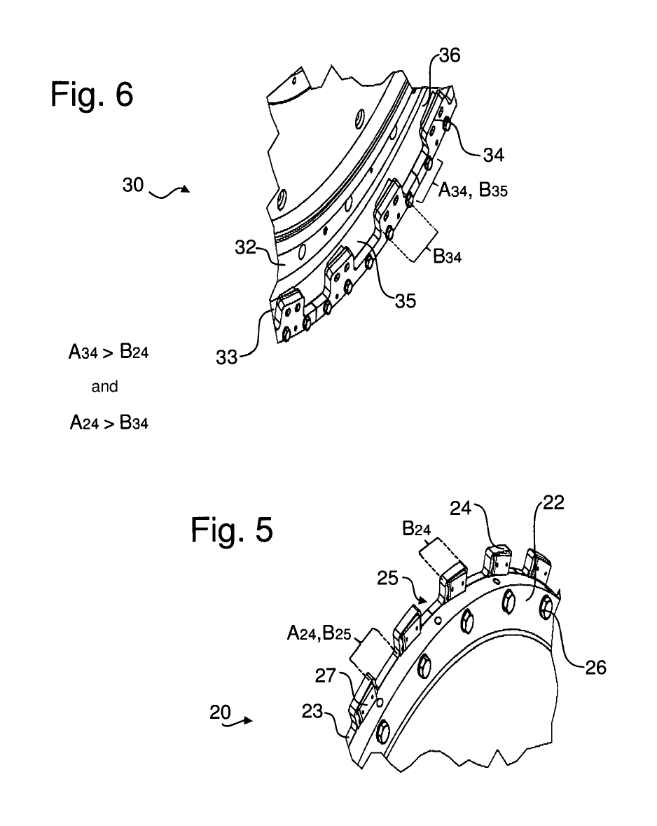

FIGS. 3 to 10 show different views and details of a first embodiment of a closure system according to the invention for a ball mill. FIG. 3 represents a detail of a horizontally mounted cylindrical grinding container 20, in particular the region of open second end wall 21 with grinding container flange 22, and FIG. 5 shows a detail in respect thereof. A ring 23 with an outer toothing system is disposed on grinding container flange 22 on the lid side. Ring 23 is fastened for example to grinding container flange 22 by means of screw connections 26. So-called outer-tooth gaps 25 are present between outer teeth 24. The distance between the centre point of ring 23 and the point disposed closest to the latter in outer-tooth gaps 25 is preferably identical to the radius of grinding container flange 22. This means that outer teeth 24 project beyond grinding container flange 22.

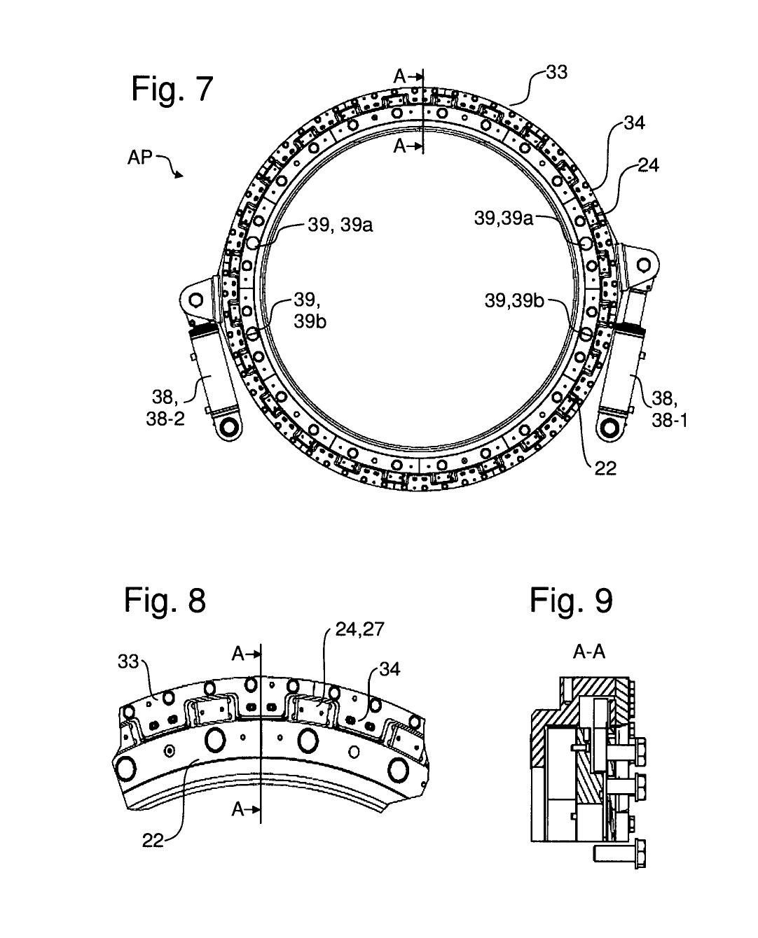

Outer teeth 24 have for example a largely cuboid shape. Average distance A24 between two outer teeth 24 or average width B25 of an outer-tooth gap 25 corresponds at least to width B24 of an outer tooth 24. Furthermore, wedge elements 27 are disposed on the container side of outer teeth 24. When wedge elements 27 are viewed from the container side, their thickness increases normal to the plane of open end face 21 in each case in the clockwise direction. When open end face 21 is closed with lid 30, these wedge elements 27 serve to produce a friction-locked connection between grinding container 20 and lid 30, which will be explained in greater detail in connection with FIGS. 7 to 10.

FIG. 4 shows a lid 30 for closing open second end wall 21 of grinding container 20 and FIG. 6 shows a detail cross-section in respect thereof. Lid 30 comprises a lid flange 32. Disposed above lid flange 32 is a large rotatable adjustment ring 33 with an inner toothing system comprising inwardly directed inner teeth 34. In particular, inner teeth 34 are positioned in front of lid flange 32, so that a free space 36 remains in each case between inner teeth 34 and lid flange 32.

Inner teeth 34 have for example a largely cuboid shape. Average distance A34 between inner teeth 34 or average width B35 of inner-tooth gap 35 corresponds at least to width B34 of inner teeth 34. In particular, width B24 of outer teeth 24 roughly corresponds to width B34 of inner teeth 34 and, in particular, average distance A34 between two inner teeth 34 is at least slightly greater than width B24 of outer teeth 24. Furthermore, an average distance A24 between two outer teeth 24 is at least slightly greater than width B34 of inner teeth 34.

Furthermore, wedge elements 37 are disposed on the lid side of inner teeth 34. When wedge elements 37 are viewed from the container side, their thickness increases normal to the plane of open end face 21 in each case anticlockwise. When open end face 21 of grinding container 20 is closed with lid 30, these wedge elements 37 together with wedge elements 27 of outer teeth 24 of ring 23 disposed on grinding container flange 22 bring about the creation of a friction-locked connection, since they further increase the contact pressure.

Two hydraulic cylinders 38 are disposed opposite one another on adjustment ring 33, with the aid whereof adjustment ring 33 is rotated. Hydraulic cylinders 38 are fastened to a bearing substructure (not represented) of the ball mill or agitator ball mill.

Grinding container 20 is mounted horizontally displaceable and for closure by lid 30 is moved towards the latter. Adjustment ring 33 must be in a working position AP according to FIG. 7 here, so that outer teeth 24 of ring 23 disposed on grinding container flange 22 are pushed in an aligned manner into or through inner-tooth gaps 35 between inner teeth 35 of adjustment ring 33 of lid 30 (see also FIG. 8). In particular, outer teeth 24 are moved so close to lid 30 that they largely abut against lid flange 32 or, as the case may be, against a sealing element or suchlike assigned to lid flange 32. In first working position AP, first hydraulic cylinder 38-1 is extended and second hydraulic cylinder 38-2 lying opposite is retracted. Adjustment ring 33 is rotated as a result of simultaneous extension of second hydraulic cylinder 38-2 and retraction of first hydraulic cylinder 38-1. Viewed from the container side, the adjustment ring rotates in the clockwise direction. As a result of the rotation of adjustment ring 33, inner teeth 34 are preferably displaced completely in front of outer teeth 24. This means that, in the locking position, outer teeth 24 are disposed completely in free space 36 between inner teeth 34 and lid flange 32. An additional friction-locked connection is produced by wedge elements 27 of outer teeth 24, said wedge elements widening in the clockwise direction, and wedge elements 37 of outer teeth 34, said wedge elements widening in the anticlockwise direction, so that grinding container 20 is closed in a sealing manner with lid 30. In particular, a force is produced in the direction of the longitudinal axis of the ball mill or grinding container 30 and therefore a firm connection between grinding container flange 22 and lid flange 32. Adjustment ring 33 is supported on the lid flange 32.

Wedge elements 27 of outer teeth 24 are preferably made from a different material from wedge elements 37 of outer teeth 34, in particular a material combination with as little adhesive friction as possible as selected. For example, wedge elements 37 of inner teeth 34 are made of steel and wedge elements 27 of outer teeth 24 of brass. Other suitable material combinations are however also conceivable.

FIG. 9 shows a cross-section A-A through a grinding container 20 in the region of an inner tooth 34, said grinding container having been moved up to lid 30.

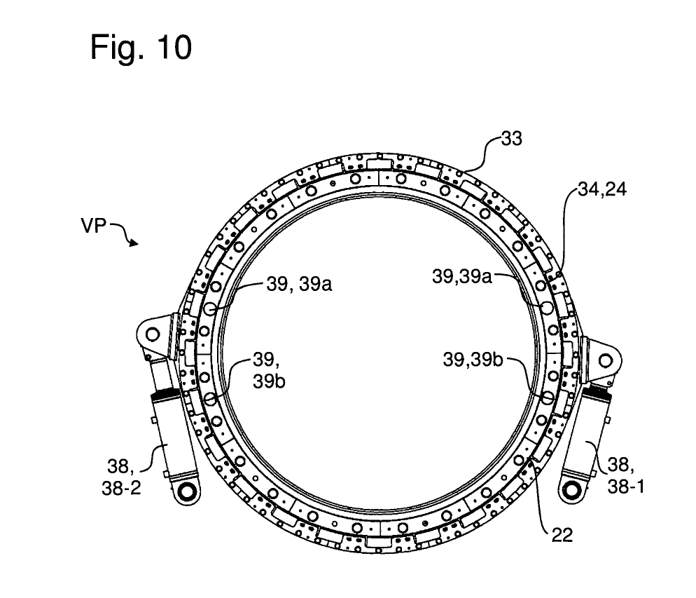

FIG. 10 shows the arrangement according to FIG. 7, wherein adjustment ring 33 is in locking position VP, wherein first hydraulic cylinder 38-1 is retracted and opposite second hydraulic cylinder 38-2 is extended. Outer teeth 24 are disposed here in free spaces 26 between inner teeth 34 of adjustment ring 33 and lid flange 32 and the friction-locked sealing fastening of lid 30 to grinding container 20 is produced by wedge elements 37, 27 (not shown, see FIGS. 6, 7). For the opening of lid 30, adjustment ring 33 is rotated anticlockwise, wherein the first hydraulic cylinder 38-1 is extended and opposite second hydraulic cylinder 38-2 is retracted. The closure system thus arrives back into a working position AP according to FIG. 7, in which outer teeth 24 of ring 23 disposed on grinding container flange 22 are pushed in an aligned manner into or through inner-tooth gaps 35 between inner teeth 35 of adjustment ring 33 of lid 30. Grinding container 20 can now be moved away from lid 30 by horizontal displacement.

The closure system according to the represented first embodiment is suitable for the method according to the invention for opening and closing ball mills. In the closure system according to the represented first embodiment, inner-tooth gaps 35 are a component part of a rotatable adjustment ring 33 and represent the first connecting devices of the closure device, i.e. lid 30. Outer teeth 24 assigned to grinding container flange 22 represent the second connecting devices on grinding container 20. In first open working position AP of adjustment ring 33, outer teeth 24 engage through inner-tooth gaps 35. By rotation in the clockwise direction, adjustment ring 33 is transferred into closed locking position VP. Outer teeth 24 are thereby rotated with respect to inner-tooth gaps 35 in such a way that the outer teeth are now located in free space 36 between inner teeth 34 and lid flange 32. Wedge elements 37, 27 as means producing a friction-locked connection are assigned both to inner teeth 34 and to outer teeth 24, said wedge elements in locking position VP bringing about a clamped operative connection between lid 30 and grinding container 20 in a friction-locked manner.

Furthermore, the arrangement of centring means 39 is indicated in FIG. 7. Lid flange 32 comprises for example two upper and two lower centring pins 39a, 39b, which each point in the direction of grinding container 20. If grinding container 20 is pushed against lid 30, centring pins 39a, 39b engage in corresponding bores of grinding container flange 22 and centring pins 39a, 39b are guided in the latter.

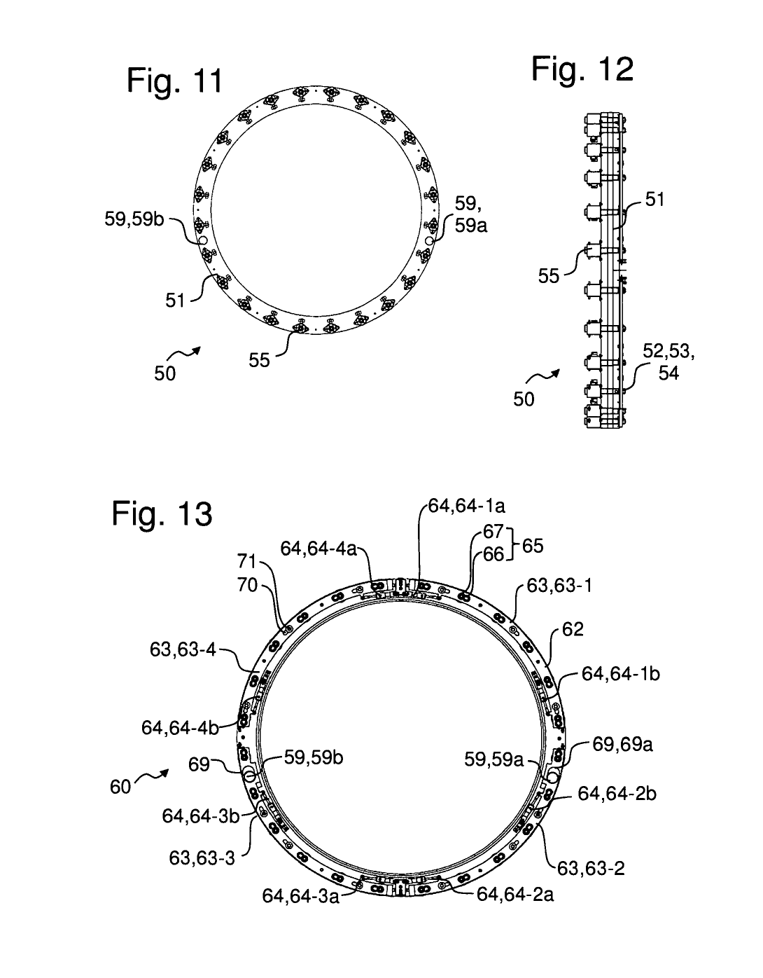

FIGS. 11 to 17 show different views and details of a second embodiment of a closure system according to the invention for a ball mill. FIGS. 11 and 12 show a front view and a side view of a lid 50. Lid 50 comprises a lid flange 51, to which a plurality of first connecting devices 52 is assigned. First connecting devices 52 are constituted in particular as bolts 53 with a mushroom-like widened end region 54. Widened end region 54 of first connecting devices 52 is constituted in each case on the side of lid 50 facing grinding container 60. The other end of respective bolt 53 is connected in each case to a hydraulic cylinder 55, by means of which bolt 53 can be displaced parallel to the longitudinal axis of grinding container 60.

FIG. 13 shows a plan view of grinding container flange 62 of a grinding container 60 as viewed from the container side. Four adjustment segments 63 are disposed at the so-called rear side of grinding container flange 62. Each adjustment segment 63 comprises six second connecting devices 65, which are correspondingly a component part of respective adjustment segment 63. Second connecting devices 65 each comprise slotted holes, which connect a through-passage region 66 to a support region 67 for widened end region 54 of first connecting devices 52. Bolt rod 53 of first connecting device 52 itself always stands free in the slotted hole, through-passage region 66 and support region 67. In alignment with through-passage regions 66 of second connecting devices 65 on adjustment element 63, grinding container flange 62 comprises corresponding through-passage openings (not represented) for first connecting devices 52.

FIG. 11 is represented reduced in size compared to FIGS. 12 and 13. The diameters of grinding container flange 62 and lid flange 51 are at least largely identical.

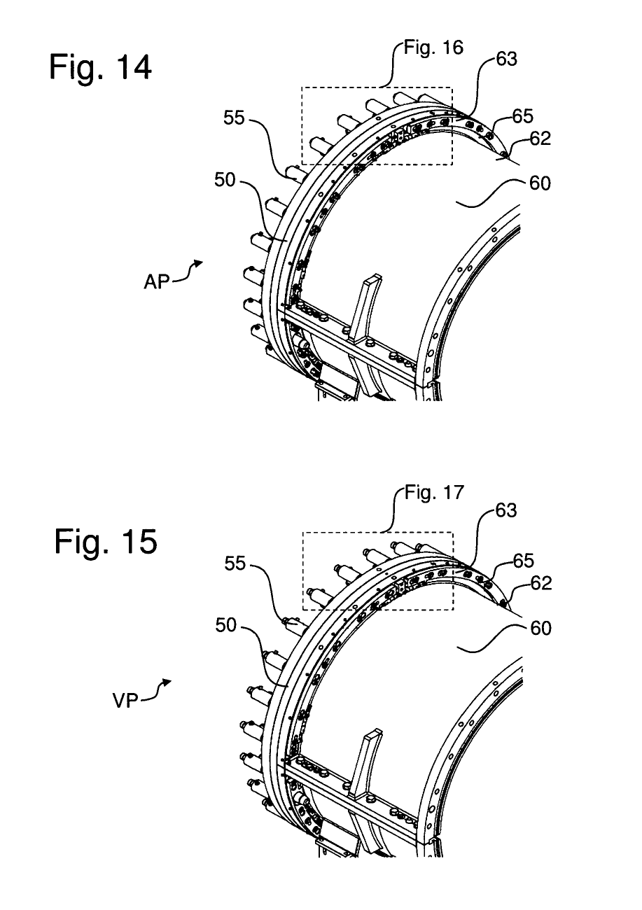

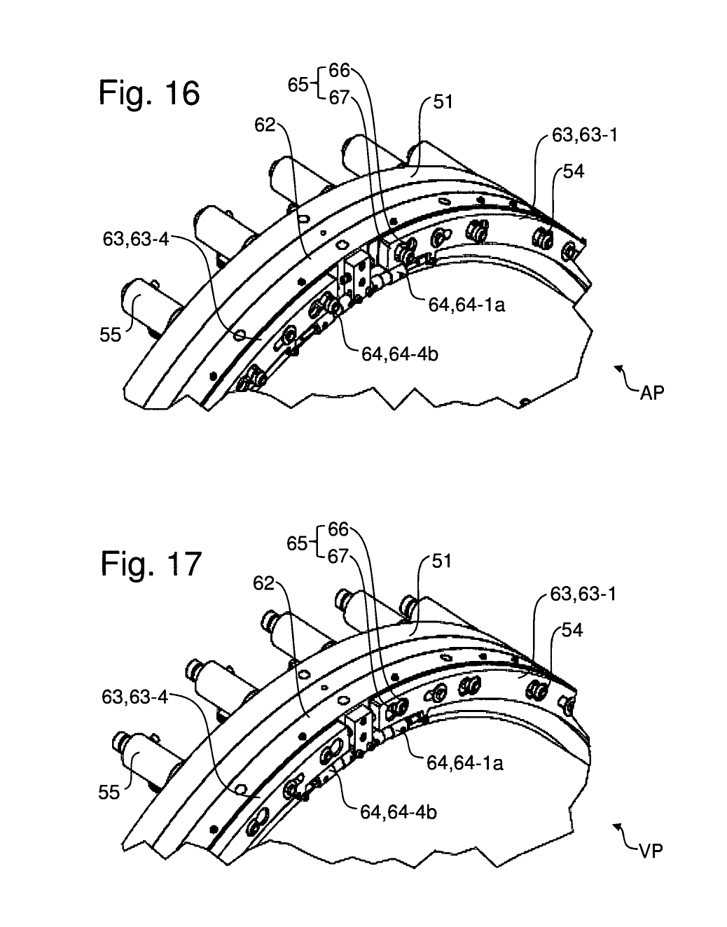

FIG. 14 shows a grinding container 60 moved up to lid 50, wherein adjustment segments 63 are in working position AP, and FIG. 15 shows a grinding container 60 moved up to lid 50, wherein adjustment segments 63 are in locking position VP. FIGS. 16 and 17 each show detail views in respect thereof, particularly the region in which adjustment segments 63-1 and 63-4 are largely adjacent to one another.

In open working position AP of adjustment segments 63, first fastening devices 52 engage through the through-passage openings (not represented) of grinding container flange 62 and respective through-passage regions 66 of second connecting devices 65 on adjustment segments 63. Bolts 53 are adjusted by means of hydraulic cylinders 55 especially in such a way that mushroom-like widened end regions 54 on the side facing grinding container 60 project beyond adjustment segments 63, after grinding container 60 has been moved as close as possible to lid 50 for the closure. This can be seen particularly well in FIG. 16.

Two hydraulic cylinders 64, 64-1a and 64-1b etc., are assigned in each case to the four adjustment segments 63-1 to 63-4, said hydraulic cylinders bringing about a targeted rotation of adjustment segments 63. By lengthening hydraulic cylinder 64-1b and shortening hydraulic cylinder 64-1a, adjustment segment 63-1 is transferred anticlockwise into locking position VP. By lengthening hydraulic cylinder 64-2b and shortening hydraulic cylinder 64-2a, adjustment segment 63-2 is transferred by a rotation in the clockwise direction into locking position VP. By lengthening hydraulic cylinder 64-3b and shortening hydraulic cylinder 64-3a, adjustment segment 63-3 is transferred anticlockwise into locking position VP, and by lengthening hydraulic cylinder 64-4b and shortening hydraulic cylinder 64-4a, adjustment segment 63-4 is transferred by a rotation in the clockwise direction into locking position VP. The adjustment of the four adjustment segments 63-1 to 63-4 by means of hydraulic cylinders 64 is preferably controlled jointly and takes place largely synchronously. This means that the four largely quarter-circle-shaped adjustment segments are each transferred into their closed locking position by rotation in the clockwise or anticlockwise direction. In the represented example of embodiment, two of adjustment segments 63-2 and 63-4 rotate in the clockwise direction and the other two adjustment segments 63-1 and 63-3 rotate in the anticlockwise direction when the adjustment segments are transferred from the working position into the locking position. Alternatively, it would be conceivable for hydraulic cylinders 64 to be disposed in such a way that all adjustment segments 63 rotate in a common direction of rotation. It is important here that mushroom-like widened end regions 54 of first connecting devices 52 project freely beyond adjustment segments 63 during the rotation of adjustment segments 63.

The rotation of adjustment segments 63-1 to 63-4 is also guided by guide screws 71 guided in slotted holes 70.

In closed locking position VP, first connecting devices 52 and second connecting devices 65 are rotated towards one another. In particular, second connecting devices 65 have been rotated with respect to first connecting devices 52 in such a way that mushroom-like widened end regions 54 of first connecting devices 52 are now disposed directly on support regions 67 of second connecting devices 65.

First connecting devices 52 are withdrawn by means of hydraulic cylinders 55 assigned to first connecting devices 52. This movement is limited by widened end regions 54 of first connecting devices 52 and support regions 67 of second connecting devices 65. In particular, a friction-locked connection is produced between mushroom-like widened end regions 54 of first connecting devices 52 and support regions 67 of second connecting devices 65. This means that hydraulic cylinders 55 form the means producing the friction-locked connection, by means of which an operative connection between lid 50, in particular lid flange 51, and grinding container 60, in particular grinding container flange 62, is constituted in a friction-locked manner.

Furthermore, the arrangement of centring means is also indicated in FIGS. 11 and 13. Lid flange 51 comprises two centring pins 59 pointing in the direction of grinding container 60. Said centring pins engage in corresponding bores (not represented) of grinding container flange 62 and are guided in the latter. Adjustment segments 63-2 and 63-3 comprise slotted holes 69 aligned with the bores in grinding container flange 62. Slotted holes 69 are necessary in order that a rotation of adjustment segments 63-2 and 63-3 is possible despite centring. FIG. 13 shows the arrangement of centring pins 59 of lid flange 51 in slotted holes 69 of adjustment segments 63-2 and 63-3. FIG. 13 shows adjustment segments 63 in working position AP and illustrates the fact that centring pins 59 do not prevent the rotation of adjustment segments 63 from occupying locking position VP (see FIGS. 15 and 17). In particular, slotted hole 69a enables a rotation of adjustment segment 63-2 in the clockwise direction and slotted hole 69b enables a rotation of adjustment segment 63-3 in the anticlockwise direction.

The invention has been described by reference to a preferred embodiment. A person skilled in the art can however imagine that modifications or changes to the invention can be made without thereby departing from the scope of protection of the following claims.

1. A closure system for ball mills, wherein the ball mill comprises a grinding container with an end-face opening, which can be closed with a closure device, wherein the closure device comprises a first flange with first connecting devices and the end-face opening of the grinding container comprises a second counter-flange with second connecting devices, wherein the closing device can be fastened to the grinding container by means of the first and the second connecting devices, characterised in that the first or the second connecting devices are a component part of at least one rotatable, at least partially annular adjustment element, wherein the first and second connecting devices engage loosely through or into one another in an open working position of the least one, at least partially annular adjustment element, wherein the at least one at least partially annular adjustment element can be transferred by a rotation into a second closed locking position, wherein, in the closed locking position, the first and second connecting devices are rotated towards one another and wherein the closure system comprises means for producing a friction-locked connection, by means of which a clamped operative connection between the closure device and the grinding container can be constituted in a friction-locked manner.

2. The closure system according to claim 1, wherein the grinding container is disposed horizontally mobile and the connecting device is disposed at least largely stationary and wherein the grinding container can be traversed into a first closure position, in which the first connecting devices and the second connecting devices engage loosely into or through one another.

3. The closure system according to claim 1, wherein at least one hydraulic, pneumatic and/or electric adjustment means for the rotation is assigned to the at least one rotatable, at least partially annular adjustment element.

4. The closure system according to claim 1, wherein the first connecting devices of the closure device are a component part of a rotatable annular adjustment element, wherein, in the open working position of the adjustment element, the first connecting devices are in a first open position, so that the second connecting devices of the grinding container engage in an aligned manner into or through the first connecting devices, wherein, by rotation of the adjustment element into a second locking position, the first connecting devices can be transferred into a second, at least partially closed position, wherein the first and the second connecting devices are rotated at least partially towards one another.

5. The closure system according to claim 4, wherein an external ring is assigned as a rotatable, annular adjustment element to the first flange of the closure device, said external ring having an external diameter that is greater than an external diameter of the first flange, and wherein the external ring comprises first teeth directed towards the ring centre-point, wherein the first connecting devices are constituted by gaps between the first teeth, wherein at least one free space is constituted at least in regions between the first teeth and the first flange or wherein the first teeth have an undercut constituted towards the first flange, wherein the second connecting devices project in regions beyond the external diameter of the grinding container flange and wherein the second connecting devices can be pushed into or pushed through the first connecting devices in the first open working position of the external ring and wherein the second connecting devices, in the closed locking position of the external ring, are disposed at least partially in the free space or in the region of the undercut behind the first teeth of the external ring.

6. The closure system according to claim 5, wherein wedge elements are assigned to the second connecting devices on a side facing the grinding container, said wedge elements widening against the first direction of rotation of the external ring of the closure device and, in the closed locking position, being disposed at least partially in the free space or in the undercut behind the first teeth.

7. The closure system according to claim 6, wherein the external ring with the first teeth and the grinding container flange are made of a first material and wherein the wedge elements on the second connecting devices are made of a second, wherein the first is not the same as the second material, in particular wherein the first material is steel or special steel and the second material is brass or a copper-zinc alloy.

8. The closure system according to claim 1, wherein a plurality of rotatable, partially annular adjustment elements with two connecting devices is assigned to the grinding container flange, in particular wherein four largely quarter-circle-shaped adjustment elements are assigned to the grinding container flange, wherein, in the open working position of the adjustment element, the second connecting devices are located in a first open position, so that the first connecting devices of the closure device engage in an aligned manner through the second connecting devices, wherein the second connecting devices can be transferred into a second closed position by rotation of the adjustment elements into a second locking position.

9. The closure system according to claim 8, wherein means for the axial displacement along a longitudinal axis of the grinding container are assigned, as means producing a friction-locked connection, to each of the first connecting devices, in particular wherein a hydraulic device for the axial displacement of the first connecting devices is assigned to each first connecting device.

10. The closure system according to claim 8, wherein the first connecting devices are constituted as bolts with a widened free end region and wherein the second connecting devices comprise a through-passage region and a support region with a support face for the widened end region of the first connecting devices, wherein, in the working position of the rotatable partially annular adjustment elements, the free end regions of the first connecting devices engage through the through-passage region of the second connecting devices, wherein, in the locking position of the rotatable partially annular adjustment elements, the free end regions of the first connecting devices are positioned in front of the support region of the second connecting devices and wherein, in the locking position, a friction-locked connection between the closure device and the grinding container can be produced by means of the hydraulic devices assigned to the first connecting devices.

11. The closure system according to claim 8, wherein at least two hydraulic cylinders for generating the rotary motion are assigned to each rotatable partially annular adjustment element.

12. A method for opening and closing ball mills, wherein the ball mill comprises a horizontally disposed grinding container with an end-face opening, which can be closed with a closure device, wherein the ball mill comprises a closure system with at least one rotatable, at least partially annular adjustment element with first connecting devices on the closure device or with second connecting devices on the grinding container, wherein, in a working position of the at least one rotatable, at least partially annular adjustment element, the first and the second connecting devices engage into or through one another in an aligned manner and wherein the at least one adjustment element is transferred by rotation into a second closed locking position, wherein the first and second connecting devices are rotated towards one another and wherein, by virtue of means producing a friction-locked connection, a clamped operative connection between the closure device and the grinding container is produced in a friction-locked manner.

13. The method according to claim 12, wherein, for the closing of the ball mill, the grinding container is pushed in the axial direction towards the closure device and, after the first and second connecting devices have engaged into or through one another, the at least one adjustment element is rotated in the first direction of rotation and a friction-locked connection between the closure device and the grinding container is produced.

14. The method according to claim 12, wherein, for the opening of the ball mill, the friction-locked connection between the closure device and the grinding container is released and the adjustment element is rotated in a second counter-direction and wherein, by moving the grinding container in the axial direction away from the closure device, the first and second connecting devices disposed engaging into or through one another in an aligned manner are spaced apart from one another.

15. The closure system according to claim 2, wherein at least one hydraulic, pneumatic and/or electric adjustment means for the rotation is assigned to the at least one rotatable, at least partially annular adjustment element.

16. The closure system according to claim 9, wherein the first connecting devices are constituted as bolts with a widened free end region and wherein the second connecting devices comprise a through-passage region and a support region with a support face for the widened end region of the first connecting devices, wherein, in the working position of the rotatable partially annular adjustment elements, the free end regions of the first connecting devices engage through the through-passage region of the second connecting devices, wherein, in the locking position of the rotatable partially annular adjustment elements, the free end regions of the first connecting devices are positioned in front of the support region of the second connecting devices and wherein, in the locking position, a friction-locked connection between the closure device and the grinding container can be produced by means of the hydraulic devices assigned to the first connecting devices.
